(19) United States
(12) Patent Application Publication
(10) Pub. No.: US 2006/0268565 A1
(43) Pub. Date: Nov. 30, 2006

(54) Led lighting device with light diffusing effect

(75) Inventor: Hsiang-Chun Chang, Taichung (TW)

Correspondence Address: PATENTTM.US, P. O. BOX 82788, PORTLAND, OR, 97282-0788, US

(73) Assignee: HAOLI PRECISION INDUSTRIAL CO., LTD.

(21) Appl. No.: 11/138,958

(22) Filed: May 25, 2005

(51) Int. Cl. B60Q 1/26

(52) U.S. Cl. 362/540; 362/800

(57) ABSTRACT

A Light Emitting Diode (LED) lighting device provides widened light distribution range. The lighting device has a base with a circuit board, a cover and a reflection plate. The circuit board has multiple light emitting diodes mounted thereon. The cover is securely connected to the casing. The reflection plate is securely mounted between the circuit board and the cover and has at least one cambered reflecting face to correspond to and partially cover parts of outer edges of the light emitting diodes.

### BACKGROUND OF THE INVENTION

1. Field of the Invention

The present invention relates to a composition of a lighting device using light emitting diodes (LEDs) as light source, and more particularly, to a LED lighting device having light diffusing effect to widen a lighting distribution range of the lighting device.

2. Description of Related Art

Because of its high energy efficiency, long product life, and environmental friendly materials, the light emitting diode (LED) has become more and more popular as a light source in many applications. In one sort of applications thereof, the LED is used in indicating or warning lights, such as signal and brake lights of cycles and automobiles, and traffic lights, in which the light emitted from the LED has to be diffused to a wide angle so that observers viewing from different directions are able to see the light.

With reference to FIG. 4, a conventional LED lighting device with a light diffusing effect has a casing (40) composed of two portions, a circuit board (41) mounted inside the casing (40), a mounting seat (42) mounted on the circuit board (41) and having multiple LEDs (43) mounted on the mounting seat (42) and a cover (44) securely connected to the casing (40). To diffuse the light from the LEDs (43), the mounting seat (42) is divided into segments each being bent such that when the LEDs (43) are mounted on the mounting seat (42), each one of the LEDs (43) is directed to a specific direction. Thus light from the LEDs (43) is able to emit to different directions. This kind of arrangement of the LEDs does meet the purpose of diffusing the light. However, it is complicated to assemble such a device. First, the mounting seat (42) has to be mounted on the circuit board. Second, the legs of the LEDs (43) have to be inserted thought the mounting seat (42) and welded to the circuit board (41) in an upright position. Then, the LEDs (43) have to be bent 90 degrees to be parallel to the circuit board (41) and pointing to the desired direction. Not only the assembly of such a device is complicated, but also the angle of the bent LEDs (43) cannot be secured and the LEDs (43), especially the LEDs' legs, can easily be damaged during the process of bending.

With reference to FIG. 5, another conventional lighting device with light diffusing effect is shown and has a circuit board (51) in combination with a mounting seat (52). The mounting seat (52) is divided into three portions, i.e. a first portion (520), a middle portion and a second portion (521). Multiple LEDs are mounted through the middle portion onto the circuit board (51). The first portion (520) and the second portion (521) are slanted with respect to the middle portion and respectively have multiple LEDs (54) mounted therethrough and onto the circuit board (51). The first portion (520) is facing in a direction opposite to that of the second portion (521). Either first bending the LED legs and then mounting the LEDs (54) through the first portion (520) and the second portion (521), respectively, to be welded on the circuit board (51), or first mounting the LEDs (54) through the first portion (520) and the second portion (521) to be welded on the circuit board (51) and then bending the legs of the LEDs (54), the assembly process is complex and thus the manufacture cost is high. In addition, the production cost of the mounting seat (52) is also high due to its complex shape.

With reference to FIG. 6, a third conventional lighting device with light diffusing effect comprises a circuit board (61) with LEDs (62) mounted thereon. The LEDs (62) are bent to have different inclinations so that the light from the LEDs (62) is able to emit to different directions in order to attain the light diffusing purpose. But, because there is not any supporting apparatus for securely fixation of the LEDs (62), the inclination angles of the LEDs (62) are difficult to be controlled and maintained, which cause not only the difficulty in mass production, but also the instability in quality.

To overcome the shortcomings, the present invention intends to provide a lighting device to avoid the aforementioned problems while maintaining high efficacy in defusing the light.

### SUMMARY OF THE INVENTION

The primary objective of the present invention is to provide a lighting device which is easily assembled and is able to diffuse the light of the light emitting diodes (LEDs) to widen the light distribution range of the lighting device.

In one aspect of the present invention, the lighting device of the present invention has a base with a circuit board, a reflection plate and a cover. The circuit board has LEDs mounted thereon and is securely received in the base. The reflection plate is provided to reflect the light from the LEDs and has at least one cambered reflecting face corresponding to at least one of the LEDs on the circuit board. At least one of the LEDs has an outer edge partially covered by a corresponding one of the at least one reflecting face on the reflection plate. The cover is securely connected to the casing to enclose with the casing the reflection plate, the LEDs and the circuit board.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a lighting device in accordance with the present invention;

FIG. 2 is an exploded plan view of the lighting device in FIG. 1 showing the relative position among the circuit board, the reflection plate and the cover;

FIG. 3 is an operational side view in partial cross section of the lighting device in FIG. 1 showing that light emitting from the LEDs is diffused by the cambered side faces of the reflection plate;

FIG. 4 is an exploded side plan view in partial cross section of a first conventional lighting device in accordance with the prior art;

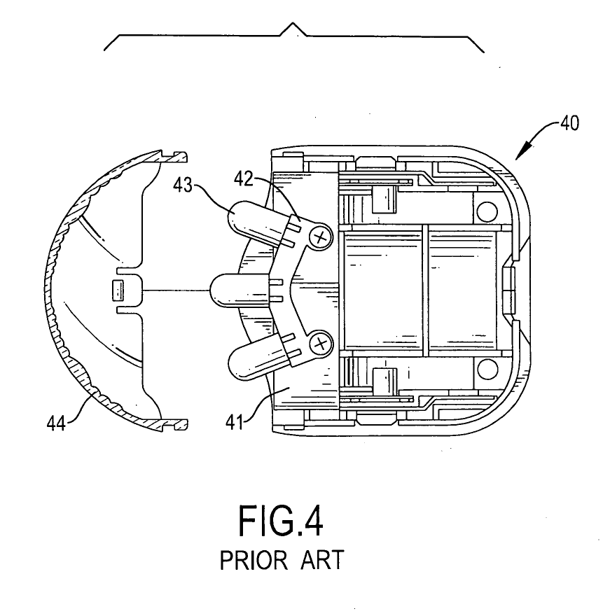

FIG. 5 is a perspective view of a second conventional lighting device in accordance with the prior art; and

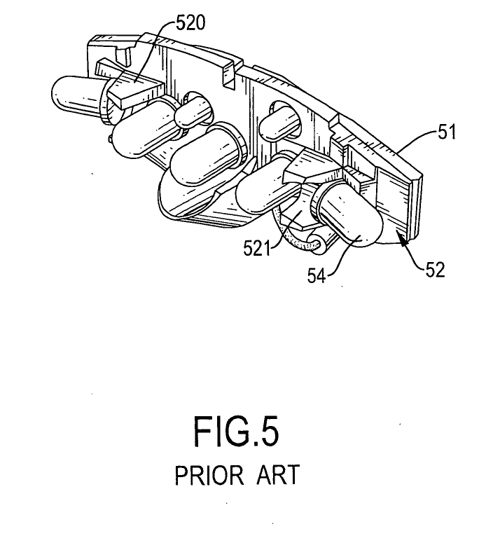

FIG. 6 is an exploded perspective view of a third conventional lighting device in accordance with the prior art.

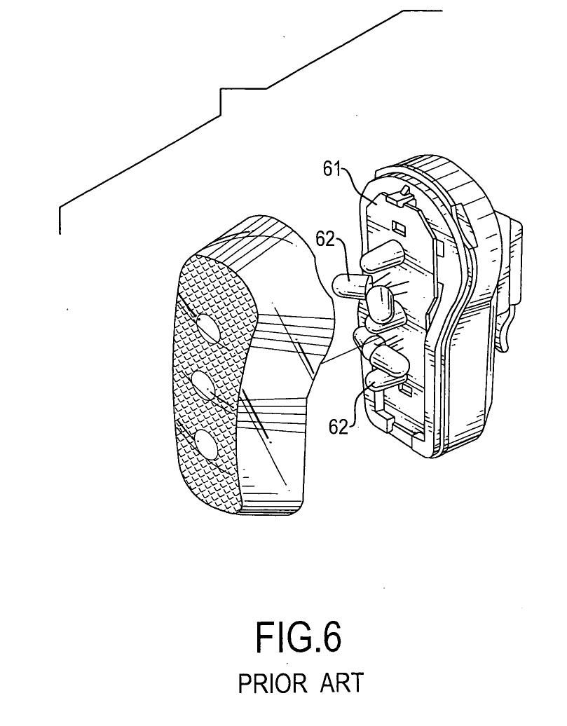

### DETAILED DESCRIPTION OF THE PREFERRED EMBODIMENT

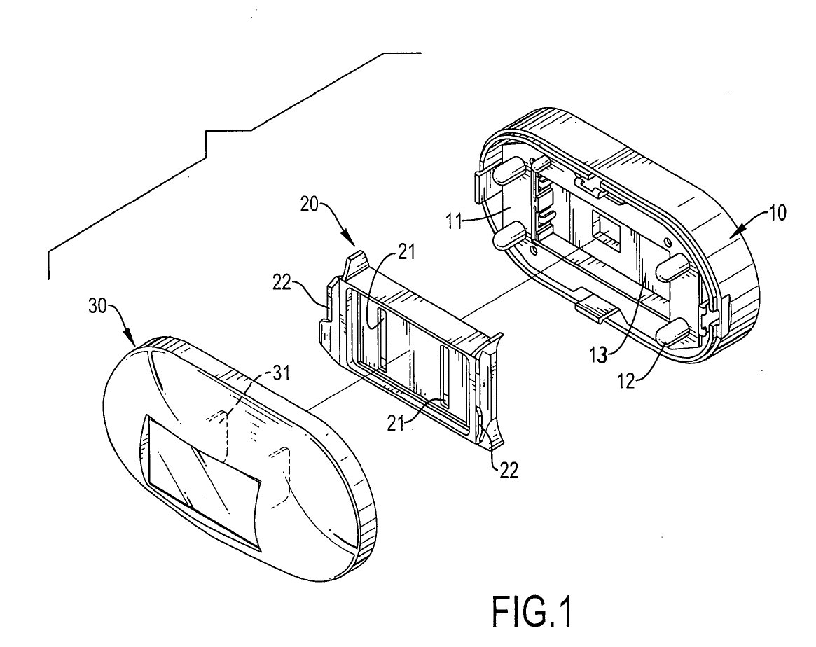

With reference to FIG. 1, it is noted that the lighting device in accordance with the present invention includes a base (10), a circuit board (11), a cover (30) and a reflection plate (20) securely mounted between the circuit board (11) and the cover (30).

The circuit board (11) is mounted on the base and has multiple light emitting diodes (LEDs) (12) mounted thereon. The circuit board (11) may have a receiving space (13) for receiving batteries.

The cover (30) is attached to the base (10) to cover the reflection plate (20) and the circuit board. The cover (30) may have multiple spacers (31) extending from a bottom face thereof to correspond to hold the batteries received in the receiving space (13) in the circuit board (11) in place.

The reflection plate (20) is mounted between the circuit board (11) and the cover (30) and has at least one cambered reflecting face corresponding to at least one of the LEDs (12) on the circuit board (11). In a preferred embodiment, two cambered reflecting faces (22) are respectively formed on two opposed sides of the reflection plate (20) to correspond to the LEDs (12). Each LED (12) has an outer edge partially covered by a corresponding reflecting face (22) on the reflection plate (20). The reflection plate may further have multiple slits (21) defined through the reflection plate (20) corresponding respectively to the spacers (31) on the cover (30). The spaces (31) extend respectively through the slits (21) in the reflection plate (20) and abut against the batteries to hold the batteries in place.

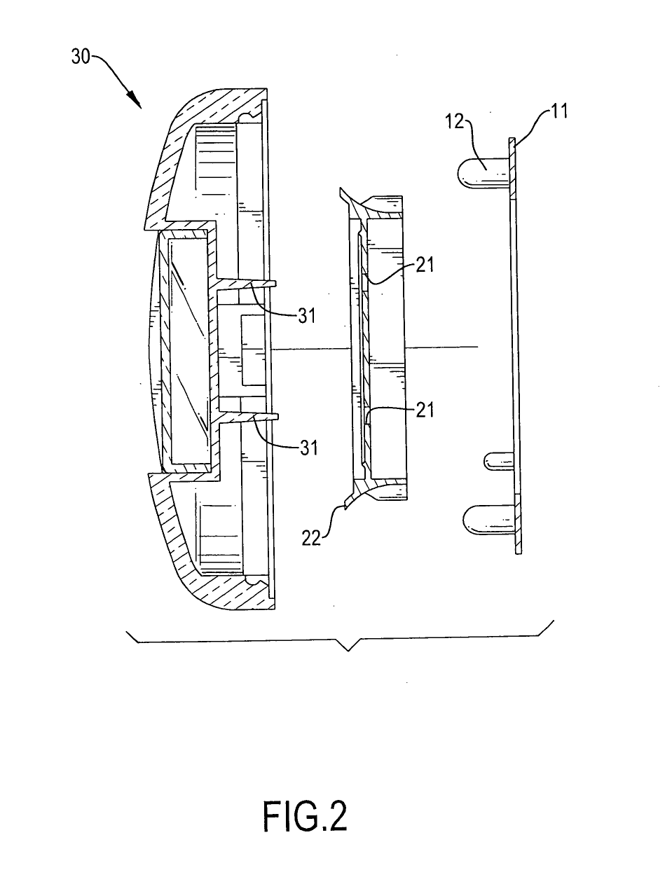

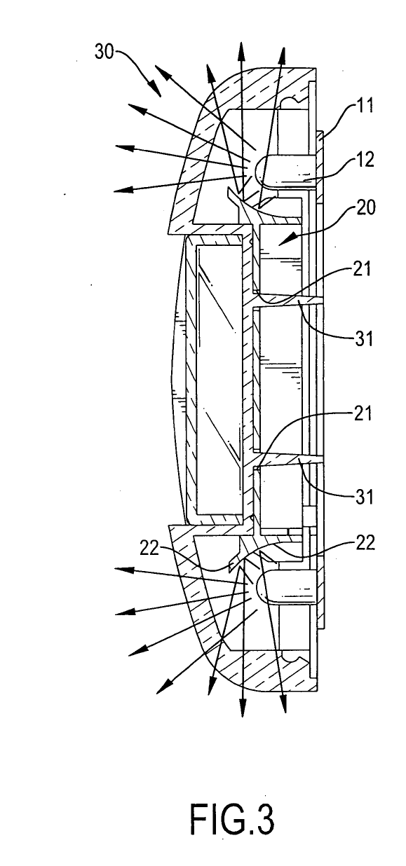

With reference to FIGS. 2 and 3, because the LEDs (12) are partially covered by the reflecting faces (22) on the reflection plate (20), part of the light emitted from the LEDs (12) will pass directly through the cover (30) in a straight direction and the rest of the light emitted from the LEDs (12) will be reflected by the cambered reflecting faces (22). With the reflection effect provided by the reflecting faces (22), a portion of the light from the LEDs (12) is diffused sideways and thus the light distribution range of the lighting device is widened, and the warning or indicating effect of the lighting device is enhanced. With different cambered angles and areas of the reflecting faces (22), the diffusing rang and distribution pattern of the light provided by the lighting device in accordance with the present invention can be modified and adjusted during manufacturing. Further, because the LEDs (12) are directly mounted onto the circuit board (11) without bending legs of the LEDs (12), nor through a LED mounting seat, the assembly process is simple and thus the cost is low.

It is to be understood, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A lighting device comprising:
a base having a circuit board securely mounted thereon and with multiple light emitting diodes (LEDs) on the circuit board;
a cover securely connected to the base; and
a reflection plate securely mounted between the circuit board and the cover and having at least one cambered reflecting face formed on the reflection plate,
wherein at least one of the light emitting diode has an outer edge partially covered by a corresponding one of the at least one reflecting face on the reflection plate.

2. The lighting device as claimed in claim 1, wherein the circuit board is a planar board.

3. The lighting device as claimed in claim 2, wherein
the circuit board has a receiving space defined in the circuit board;
the reflection plate has multiple slits defined through the reflection plate; and
the cover has multiple spacers extending from a bottom face of the cover to extend through the slits in the reflection plate and into the receiving space to hold batteries in place.

4. The lighting device as claimed in claim 3, wherein the reflection plate has two reflecting faces respectively formed on two opposed sides of the reflection plate.

5. The lighting device as claimed in claim 1, wherein
the circuit board has a receiving space defined in the circuit board;
the reflection plate has multiple slits defined through the reflection plate; and
the cover has multiple spacers extending from a bottom face of the cover to extend through the slits in the reflection plate and into the receiving space to hold batteries in place.

6. The lighting device as claimed in claim 5, wherein the reflection plate has two reflecting faces respectively formed on two opposed sides of the reflection plate.

7. The lighting device as claimed in claim 2, wherein the reflection plate has two reflecting faces respectively formed on two opposed sides of the reflection plate.

8. The lighting device as claimed in claim 1, wherein the reflection plate has two reflecting faces respectively formed on two opposed sides of the reflection plate.
